(19) United States
(12) Patent Application Publication
(10) Pub. No.: US 2005/0249386 A1
(43) Pub. Date: Nov. 10, 2005

(54) Pointing device having fingerprint image recognition function, fingerprint image recognition and pointing method, and method for providing portable terminal service using thereof

(75) Inventor: Sung Chul Juh, Seoul (KR)

Correspondence Address: MERCHANT & GOULD PC, P.O. BOX 2903, MINNEAPOLIS, MN, 55402-0903, US

(73) Assignee: Mobisol

(21) Appl. No.: 10/520,651

(22) PCT Filed: Jun. 30, 2004
(86) PCT No.: PCT/KR04/01602

§ 371 Date: Jan. 7, 2005

(30) Foreign Application Priority Data
Jun. 30, 2003 (KR) 10- 2003-0043841
Aug. 13, 2003 (KR) 10-2003-0056072
Sep. 4, 2003 (KR) 10-2003-0061676

(51) Int. Cl. G06K 9/00; G09G 5/00

(52) U.S. Cl. 382/124; 345/173

(57) ABSTRACT

A pointing device having a fingerprint recognition function, a fingerprint image recognition and pointing method, and a method for providing a portable terminal service using the same are disclosed. In the pointing device having a fingerprint recognition function and a fingerprint recognition method, fingerprint images having small sizes are mapped to generate a large fingerprint image or a small fingerprint image extracted from the large fingerprint image so that the pointing device performs user recognition and pointer control. As a result, respective sensors for the user recognition and for the pointer control are not comprised in the pointing device, but only one kind of sensors for performing both functions of user recognition and pointer control is comprised in the pointing device according to an embodiment of the present invention. Also, it is possible to easily embody miniaturization of a portable terminal device because the user recognition which requires a large fingerprint can be performed only with a small fingerprint image, thereby reducing manufacturing cost. Additionally, important information in the portable terminal device having the pointing device can be protected by selectively limiting kinds of service usable in the portable terminal device depending on user recognition.

### TECHNICAL FIELD

The present invention generally relates to a pointing device having a fingerprint image recognition function and a fingerprint recognition method thereof, and more specifically, to a pointing device for performing a user recognition and a point control by using one kind of sensors without using both a user recognition sensor and a point control sensor and a fingerprint image recognition method thereof.

### BACKGROUND ART

In general, a pointer that is a pointing device refers to a XY tablet, a trackball and a mouse which have been widely used in a desktop computer or to a touch screen panel or a touch pad which have been widely used in a portable terminal device such as a laptop computer. Recently, an optical mouse using light has been used.

Attempts to integrate biometrics into electronics and communications equipment and its peripheral equipment have recently increased. The most remarkable characteristic of the biometrics is to relieve troubles of loss, stealing, oblivion or reproduction resulting from external factors in any case, and this characteristic is most advantageous. When the characteristic is used, an audit function is completely performed to trace who violates security. Specifically, a user recognition technology with a fingerprint have been actively commercialized, and it is easy to access and carry the user recognition technology because it recognizes a user by using a characteristic of human. As a result, various studies have been made and also much development has been made in this field.

Recently, a technology where user recognition using a fingerprint is introduced to a pointing device has been developed. In the pointing device, an inner fingerprint recognition device recognizes a fingerprint from a finger surface through a predetermined window, and compares a previously registered fingerprint with the recognized fingerprint to certify the fingerprint when the comparison result is identical independently of a pointing function. FIG. 1 shows a fingerprint recognition optical mouse for an example. As shown in FIG. 1, the fingerprint recognition optical mouse 1 has the same shape and the same function as those of a general mouse, but comprises a fingerprint recognition window 2 in a portion whereon a right thumb touches. If the right thumb touches the fingerprint recognition window 2, the inner fingerprint recognition sensor (not shown) recognizes a fingerprint of the thumb and compares a previously registered fingerprint with the recognized fingerprint to determine recognition of a user.

In case of a conventional fingerprint recognition, a fingerprint having the least size necessary in user recognition is to be acquired. That is, in case of the fingerprint recognition optical mouse of FIG. 1, a fingerprint of about 100×100 pixels for fingerprint recognition is to be acquired. Currently, an optical mouse for detecting a fingerprint image of 96×96 pixels at one time has been commercialized in the market.

Also, the fingerprint recognition may be introduced to a pointing device using a fingerprint. In other words, a technology of controlling a pointer using a fingerprint and recognizing a user with the fingerprint at the same time has been provided in the current pointing device. However, in the prior art, both a fingerprint acquiring sensor for fingerprint recognition to acquire a larger fingerprint image for user recognition and a fingerprint acquiring sensor for controlling a pointer to acquire a smaller fingerprint image are comprised in the one pointing device.

FIG. 2 shows a portable terminal device comprising two fingerprint acquiring sensors. FIG. 2(a) illustrates a part of a portable computer (laptop computer) and FIG. 2(b) illustrates a part of a PDA. In case of FIG. 2(a), a fingerprint acquiring sensor 3 for fingerprint recognition which recognizes a fingerprint of a user to certify the fingerprint of the user and a pointer controlling sensor 4 for controlling a pointer represented in a monitor of a laptop computer with a finger are comprised. However, a pointer control in the laptop computer is not to use fingerprint recognition but to use change of capacitance by pressure of a finger or a stylus. Also, in case of FIG. 2(b), a fingerprint acquiring sensor 5 for user recognition and a pointer controlling sensor 6 are comprised, respectively. Generally, in case of a laptop computer for controlling movement of a cursor on a monitor depending on movement information of a finger, the fingerprint image of about 20×20 pixels is sufficient to obtain the movement information of the fingerprint for point control, but for user identification, the fingerprint image of more than about 100×100 pixels is required. In case of the actual laptop computer, a product to acquire image data of about 100×100 pixels with a fingerprint acquiring sensor of about 5×5 mm has been commercialized.

Although a low power high speed is embodied by using small data of about 20×20 pixels for point control, it is necessary to acquire and analyze a large fingerprint image of 100×100 pixels for fingerprint recognition. As a result, fingerprint acquiring sensors 3 and 5 for user recognition and pointer controlling sensors 4 and 6 are required. Since two kinds of fingerprint acquiring sensors are comprised in the pointing device, the exterior of the pointing device does not look good and the technical complexity for driving the two fingerprint acquiring sensors cannot be solved. Therefore, since two kind of fingerprint acquiring sensors are mounted in the prior art, adverse effects are caused on part miniaturization as electronic devices and apparatuses become thinner and simpler.

Accordingly, a method for performing a user recognition by using a fingerprint acquiring sensor for user recognition in a portable terminal device and performing a point control by acquiring a plurality of small fingerprint images at the same time has been required.

### BRIEF DESCRIPTION OF THE DRAWINGS

FIG. 1 is a perspective view of a conventional optical mouse for fingerprint recognition.

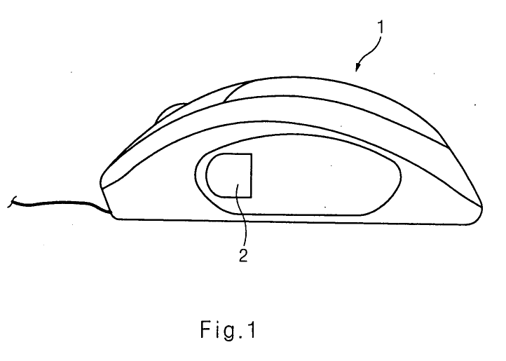

FIG. 2 is a diagram illustrating an example of a portable terminal device comprising a conventional fingerprint sensor for fingerprint recognition and a conventional navigation pad for pointer control.

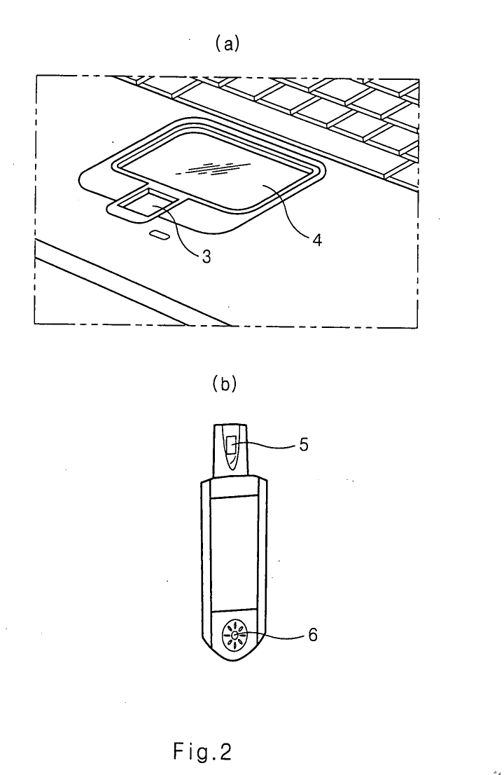

FIG. 3 is a diagram illustrating a structure of a pointing device according to a first embodiment of the present invention.

FIG. 4 is a diagram illustrating a process of calculating displacement data according to the present invention.

FIG. 5 is a diagram illustrating a process of mapping a fingerprint image according to the present invention.

FIG. 6 is a diagram illustrating a structure of a pointing device according to a second embodiment of the present invention.

FIG. 7 is a diagram illustrating a process of mapping fingerprint images acquired from a plurality of fingerprint acquiring means shown in FIG. 6.

FIG. 8 is a flow chart illustrating a fingerprint recognition process in a pointing device according to the first or the second embodiment of the present invention.

FIG. 9 is a detailed flow chart illustrating a process of mapping a fingerprint image in a virtual image space in FIG. 8.

FIG. 10 is a flow chart illustrating a process of controlling a pointer in a pointing device according to the present invention.

FIG. 11 is a diagram illustrating a structure of a pointing device according to a third embodiment of the present invention.

FIG. 12 is a diagram illustrating a design example of 3:1 reduction optics mountable in a microscopic space according to the present invention.

FIG. 13 is a diagram illustrating an example of a fingerprint image acquired from a fingerprint acquiring means by applying the reduction optic system thereto according to the present invention.

FIG. 14 is a diagram illustrating a pointing device according to a fourth embodiment of the present invention.

FIG. 15 is a diagram illustrating a method for extracting a fingerprint image of m×n pixels from that of M×N pixels.

FIG. 16 is a flow chart illustrating a method for performing a user recognition and a pointing control at the same time according to the third or the fourth embodiment of the present invention.

FIG. 17 is a diagram illustrating a structure of a pointing device according to a fifth embodiment of the present invention.

FIG. 18 is a flow chart illustrating the operation of the pointing device according to the fifth embodiment of the present invention.

FIG. 19 is a flow chart illustrating a method for limiting usage of a portable communication terminal device depending on users by using a fingerprint recognition function according to the present invention.

FIG. 20 is a diagram illustrating an example of a portable terminal device comprising a pointing device according to the present invention.

### DETAILED DESCRIPTION OF THE INVENTION

Technical Subject

It is an object of the present invention to improve a fingerprint recognition method, thereby simultaneously performing a user recognition and a pointer control with only one kind of sensors without requiring respective fingerprint recognition sensors for the user recognition and for the pointer control.

Technical Solution

In an embodiment, a pointing device having a fingerprint image recognition function comprises: at least one or more fingerprint acquiring means for acquiring a fingerprint image of a finger surface depending on a predetermined cycle; a characteristic point extracting means for extracting at least one or more characteristic points from the acquired fingerprint image; a movement detecting means for calculating displacement data between characteristic points of the extracted fingerprint image to detect movement information of the fingerprint image; a mapping means for mapping the fingerprint image in an inner virtual image space depending on the movement information; a recognizing means for comparing a previously registered fingerprint image with the whole mapped fingerprint image when the entire size of the mapped fingerprint image reaches a previously set size and determining recognition on the fingerprint; and an operating means for receiving the displacement data from the movement detecting means and calculating a direction and a distance where a pointer is to move with the displacement data.

In an embodiment, a pointing device having a fingerprint recognition function comprises: a fingerprint acquiring means (first operating cycle) for acquiring a fingerprint image of a finger surface which controls a pointer through only once 2-dimensional image acquisition; a fingerprint recognizing unit (second operating cycle) for comparing characteristic points of the previously registered fingerprint image with those of the acquired fingerprint image to recognize a user of the acquired fingerprint image; and a pointing control unit (third operating cycle) for detecting movement information based on partial data of the image acquired depending on the first operating cycle and calculating displacement data of the fingerprint image depending on the movement information to calculate movement direction and distance of the pointer.

In an embodiment, a method for recognizing a fingerprint for user recognition comprises the steps of: acquiring at least one or more fingerprint images with a predetermined fingerprint acquiring sensor depending on a set cycle; extracting at least one or more characteristic points from the acquired fingerprint image; mapping a first fingerprint image in a specific location of a virtual image space; calculating displacement data between characteristic points of the first fingerprint image and those of a second fingerprint image acquired in the next cycle after the cycle where the first fingerprint image is acquired; mapping the second fingerprint image with the displacement data in the virtual image space; and comparing characteristic points of the previously registered fingerprint image with those of the whole mapped fingerprint image when the whole size of the fingerprint images mapped in the virtual image space reaches a previously set size, and determines recognition of the fingerprint.

In an embodiment, a pointing method of a pointer control device with an image sensor having a smaller size than a predetermined size required in a fingerprint recognition comprises the steps of: acquiring at least one or more fingerprint images of M×N pixels depending on a first operating cycle with a predetermined fingerprint acquiring sensor on a finger surface which controls a movable pointer; determining recognition of a user of the fingerprint image by extracting characteristic points from the acquired fingerprint image depending on a second operating cycle and comparing the extracted characteristic points with those of the previously register fingerprint image; extracting a fingerprint image of m×n pixels from the acquired fingerprint image depending on a third operating cycle; detecting movement information of the respective fingerprint image by calculating displacement data of the extracted fingerprint image of m×n pixels; and calculating and outputting a direction and a distance where the pointer is to move with the displacement data.

In an embodiment, a pointing device having a fingerprint recognition function comprises: at least one or more fingerprint acquiring means for acquiring an image of a finger surface depending on a predetermined cycle or on occasional requirement; a movement detecting means for calculating displacement data from the acquired fingerprint image to detect movement information of each fingerprint image; an operating means for receiving the displacement data from the movement detecting means to calculate direction and distance where a pointer is to move using the displacement data; a storing means for mapping fingerprint images obtained from the fingerprint acquiring means and the operating means, and the displacement data of the fingerprint images; a CPU for analyzing and processing data of the operating means and an image storing space.

### Preferred Embodiments

The present invention will be described in detail with reference to the accompanying drawings.

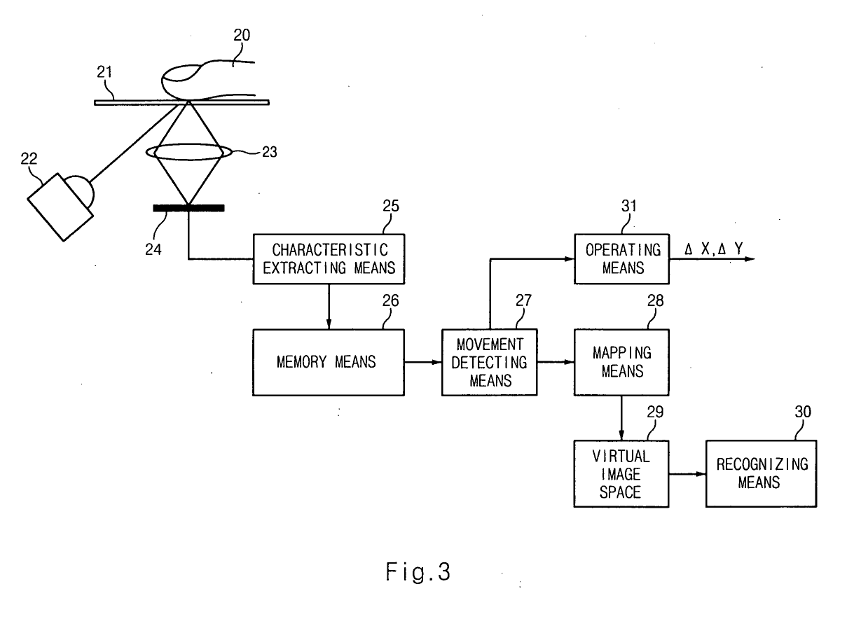

FIG. 3 is a diagram illustrating a structure of a pointing device according to a first embodiment of the present invention.

The pointing device of FIG. 3 comprises an light emitting means 22, a light gathering means 23, a fingerprint acquiring means 24, a characteristic point extracting means 25, a memory means 26, a movement detecting means 27, a mapping means 28, a virtual image space 29, a recognizing means 30 and an operating means 31.

Referring to FIG. 3, when a finger 20 to acquire a fingerprint image touches a transparent member 21, the light emitting means 22 emits light with the surface of the finger 20 which is a touch object. The light emitting means 22 includes at least one or more light emitting diodes.

The light gathering means 23 condenses a fingerprint image generated by light emitted to the touch object from the light emitting means 22. An optical convex can be used as the light gathering means 23.

The fingerprint acquiring means 24 detects an analog fingerprint image condensed by the light gathering means 23 and converts the analog fingerprint image into a digital fingerprint image. The fingerprint acquiring means 24 includes an optical sensor array where a plurality of CMOS image sensors (abbreviated as “CIS”) are 2-dimensionally arranged. Here, the fingerprint acquiring means 24 acquires a plurality of fingerprint images at a previously set cycle. The fingerprint acquiring means 24 is manufactured to be suitable for a mini-portable terminal device, thereby acquiring a small fingerprint image. For example, a micro sensor to acquire a fingerprint image of less than about 20×20 pixels suitable for pointing control is used as the fingerprint acquiring means 24. Here, devices known to a person having an ordinary skill in the art can be used for the light emitting means 22, the transparent member 21, the light gathering means 23 and the fingerprint acquiring means 24.

Light emitted from the light emitting means 22 is mirrored to the surface of the finger 20, and reflected depending on patterns of the surface of the finger 20. The light reflected from the bottom surface of the finger 20 forms a phase in the fingerprint acquiring means 24 through the light gathering means 23. The phase formed in the fingerprint acquiring means 24 is converted into a digital fingerprint image by the fingerprint acquiring means 24. The acquisition of fingerprint images is continuously performed at a rapid speed on a time axis.

The characteristic point extracting means 25 extracts at least one or more characteristic points from each fingerprint image acquired from the fingerprint acquiring means 24 in a predetermined cycle. These characteristic points includes ridge length and direction of fingerprint images, location data where ridges are separated or ended.

The memory means 26 stores fingerprint images acquired from the fingerprint acquiring means 24 and information on characteristic points extracted from the characteristic point extracting means 25.

The movement detecting means 27 detects the degree of movement of each fingerprint image from characteristic points of fingerprint images stored in the memory means 26. Here, the movement detecting means 27 detects the degree of movement of fingerprints by calculating displacement data (direction and distance) of characteristic points depending on movement of fingerprints with a motion estimation method. In this way, the movement detecting means 27 detects the degree of movement of fingerprint images by comparing characteristic points of the fingerprint images acquired in a previously set cycle. The movement information of fingerprint images and the characteristic point extraction in fingerprint recognition as well as the acquisition of fingerprint mages are importance factors because the movement of fingerprint images and the reliability of the fingerprint recognition are differentiated depending on how reliably characteristic points can be extracted.

The mapping means 28 receives displacement data (direction and distance) of characteristic points of fingerprint image, which are the movement information depending on movement of the fingerprint image from the movement detecting means 27, and determines a location where the moved fingerprint image is to be mapped in the virtual image space 29 with the displacement data. Next, the mapping means 28 maps each fingerprint image depending on the determined location. When the fingerprint image is mapped by the mapping means 28, the same characteristic points are preferably mapped to be superposed among the characteristic points acquired at the previous cycle and at the current cycle. In this way, the mapping means 28 2-dimensionally arranges fingerprint images acquired at every time in the virtual image space. Here, the virtual image space 29 has the size of the fingerprint image required in user recognition. That is, the virtual image space 29, which is a memory device for synthesizing fingerprint images required in user recognition, preferably has the size of the fingerprint image required in user recognition. For example, the virtual image space 29 has the size of less than about 100×100 pixels.

The recognizing means 30 detects whether the size of the whole fingerprint image mapped in the virtual image space 29 is identical with that of the virtual image space 29, and then compares the previously registered fingerprint image with the whole mapped fingerprint image if the size is identical to certify a user.

The operating means 31 receives displacement data from the movement detecting means 27, and calculates a direction, a distance and a movement degree where the pointer is to move with the displacement data. The operating means 30 is generally combined with a pointing device or with a processor of apparatus having the pointing device. As a result, the processor can control the pointer to move in a desired direction and at a desired distance on a screen of a display device.

In an embodiment, the fingerprint acquiring means 24 can be embodied in various ways. That is, the fingerprint acquiring means 24 can be embodied with a semiconductor device or with an optical system as described above. Here, the fingerprint acquiring means 24 using the optical system has been commercialized through a verification system for a long period, and is advantageous in scratch, temperature and durability. However, the optical system has a limitation in its usage to a mini-portable terminal device due to the size of an optical sensor, and has a problem of impossibility of information security and recognition adoption. Meanwhile, the fingerprint acquiring means 24 using a semiconductor device has a clear picture image and a rapid response speed when fingerprint image are acquired. Also, since miniaturization of the sensor is possible, the fingerprint acquiring means 24 using a semiconductor device has various application fields and large competitiveness in cost.

In an embodiment, the acquisition of fingerprint images can be performed with the optical system or the semiconductor system. For example, when fingerprint images are acquired with the semiconductor system, the above-described light emitting means 22 and light gathering means 23 are not required. As a result, FIG. 3 shows an example of the pointing device for acquiring fingerprint images with the optical system, and also fingerprint images can be acquired with the semiconductor system. Since the present invention is characterized not in acquisition of fingerprint images but in a processing method of the acquired fingerprint images, the fingerprint acquiring method can be performed with any system.

Hereinafter, the operating of the pointing device having a fingerprint recognition function will be described in detail. In an embodiment of the present invention, the fingerprint recognition function and then the pointing function are described because the fingerprint recognition function and the pointing function are simultaneously performed in the pointing device.

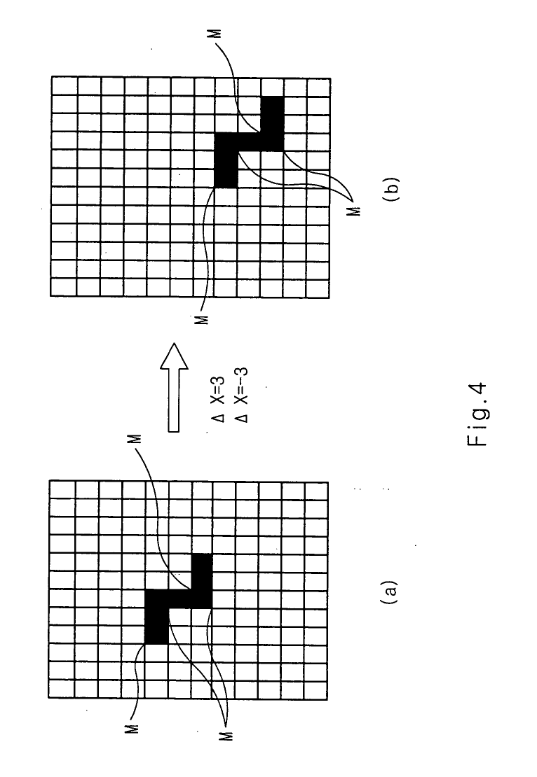

FIG. 4 is a diagram illustrating a process of calculating displacement data according to the present invention. FIG. 4a shows a fingerprint image and its characteristic points acquired in a first cycle, and FIG. 4b shows a fingerprint image and its characteristic points acquired in a second cycle. The fingerprint images of FIGS. 4a and 4b are images formed in the fingerprint acquiring means 24. In an embodiment, the fingerprint image where 5 characteristic points (represented as M) are extracted is illustrated for an example.

The fingerprint image of FIG. 4b is obtained by moving the fingerprint image of FIG. 4a rightward 3 pixels (ΔX=3) and downward 3 pixels (ΔY=−3) for a predetermined cycle. The movement detecting means 27 grasps the movement of the fingerprint image by calculating displacement data (direction and distance) of the extracted characteristic points.

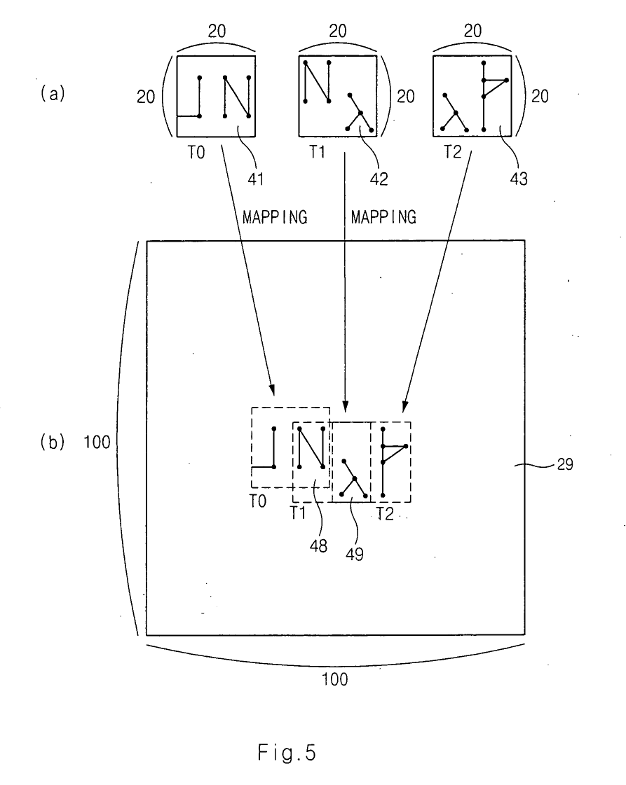

The mapping means 28 maps fingerprint images acquired at every time in a corresponding location of the virtual image space 29 with the displacement data of the characteristic points calculated by the movement detecting means 27. The mapping process is described in detail with reference to FIG. 5.

FIG. 5 is a diagram illustrating a process of mapping a fingerprint image according to the present invention.

In an embodiment, the process of acquiring a fingerprint image having a size (i.e., less than about 100×100 pixels) required in user recognition with the microminiaturized fingerprinting acquiring means 24 for acquiring a fingerprint image of less than 20×20 pixels is described.

FIG. 5a shows fingerprint images acquired depending on the previously set cycle with the microminiaturized fingerprint acquiring means 24 of less than 20×20 pixels, and FIG. 5b shows the virtual image space 29 of less than 100×100 pixels where the fingerprint images are mapped. In FIG. 5, suppose that predetermined figures are not shapes of fingerprints but patterns of figures for convenience of explanation.

When the fingerprint acquiring means 24 acquires a first fingerprint image 41 of 20×20 pixels at a timing T₀, the characteristic pint extracting means 25 extracts at least one or more characteristic points from the acquired first fingerprint image 41 and stores the characteristic points in the memory means 26. In FIG. 5a, 6 characteristic points (represented as black spots) are extracted on the first fingerprint image 41. The mapping means 28 maps the first fingerprint image 41 at a predetermined location of the virtual image space 29. Here, the mapping means 28 preferably maps the acquired fingerprint images at the center of the virtual image space 29. Thereafter, when the fingerprint acquiring means 24 acquires a second fingerprint image 42 at a timing T₁, the characteristic point extracting means 25 extracts at least one or more characteristic points (number: 8) from the second fingerprint image 42 and stores the characteristic points in the memory means 26.

The movement detecting means 27 calculates displacement data (direction and distance) with the movement information of the first fingerprint image 41 and the second fingerprint image 42. The displacement data are calculated by the method described in FIG. 4. The mapping means 28 maps the second fingerprint image 42 in locations of the virtual image space 29 corresponding to the calculated displacement data in the movement detecting means 27. Then, when the fingerprint acquiring means 24 acquires a third fingerprint image 43 at a timing T₂, the characteristic point extracting means 25 extracts at least one or more characteristic points (number: 9) from the third fingerprint image 43. These extracted characteristic points are stored in the memory means 26, and displacement data on the second fingerprint image 42 and the third fingerprint image 43 are calculated with the extracted characteristic points. The mapping means 28 maps the third fingerprint image 43 in locations of the virtual image space 29 corresponding to the calculated displacement data. As described above, the fingerprint image acquisition, the characteristic point extraction, the displacement data calculation and the mapping operation are repeatedly performed depending on a predetermined cycle until the whole size of the mapped fingerprint images 41, 42, 43, . . . , n is a size required in user recognition, that is, that of the virtual image space 29. In this way, the fingerprint image having a large size required in user recognition can be obtained with a plurality of fingerprint images each having a small size.

During the mapping operation, when the fingerprint image acquired in the current cycle is mapped in the virtual image space 29, it is preferable to map characteristic points so that at least a part of the characteristic points of the fingerprint image acquired in the previous cycle may be superposed with that of the fingerprint image acquired in the current cycle. For example, when the second fingerprint image 42 is mapped in the virtual image space 29 in FIG. 5b, at least parts of the characteristic points of the second fingerprint image 42 are mapped to be superposed with that of the characteristic points of the first fingerprint image 41. In the same way, when the third fingerprint image 43 is mapped in the virtual image space 29, at least a part of the characteristic points of the third fingerprint image 43 are mapped to be superposed with that of the characteristic points of the second fingerprint image 42. In FIG. 5b, the reference number 48 represents a portion where the first fingerprint image 41 is superposed with the second fingerprint image 42, and the reference number 49 represents a portion where the second fingerprint image 42 is superposed with the third fingerprint image 43.

Meanwhile, the second fingerprint image 42 is obtained by moving the finger 20 for a predetermined time (T1-T0) after acquisition of the first fingerprint image 41. In FIG. 3, when the finger 20 moves in a random direction at a random distance while touching the transparent member 21, the fingerprint image is acquired depending on the set cycle. In this case, the movement direction of the finger 20 is opposite to that of the fingerprint image.

As described above, the fingerprint images acquired at every time in the set cycle are mapped in the virtual image space 29. When the whole size of the mapped fingerprint images is identical with that of the virtual image space 29, the recognizing means 30 compares the previously registered fingerprint image with the whole fingerprint image mapped in the virtual image space 29 and then determines identification. Here, the identification is preferably determined through characteristic point matching of the fingerprint images. The recognizing means 30 certifies a user if the two fingerprint images are identical but refuses user certification if not. As a result, the user can restrict usage of the terminal device so that only the user can use or prevent information that the user intends to protect from leaking in a device.

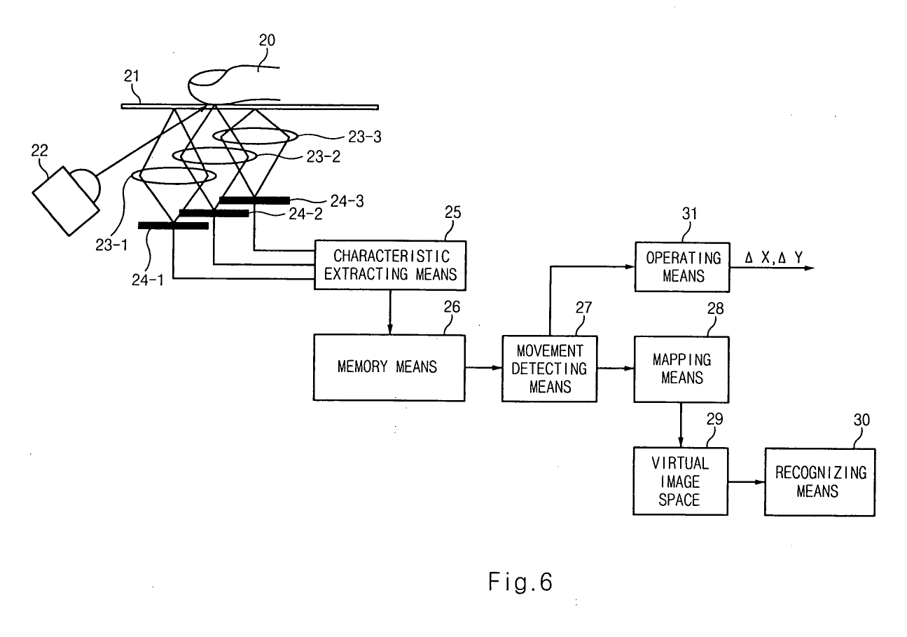

FIG. 6 is a diagram illustrating a structure of a pointing device according to a second embodiment of the present invention.

The pointing device of FIG. 6 comprises a plurality of light emitting means and fingerprint acquiring means more than that of FIG. 3. In FIG. 6, the plurality of fingerprint acquiring means 24-1, 2, 3 acquire a plurality of fingerprint images depending on a predetermined cycle at every time. In comparison with FIG. 3, while the fingerprint acquiring means 24 acquires one fingerprint image at every cycle in the pointing device of FIG. 3, each of the plurality of fingerprint acquiring means 24-1, 2, 3 acquires a fingerprint image so that a plurality of fingerprint image are acquired at every cycle in the pointing device of FIG. 6. FIG. 6 illustrates the pointing device comprising 3 light emitting means 23-1, 2, 3 and 3 fingerprint acquiring means 24-1, 2, 3.

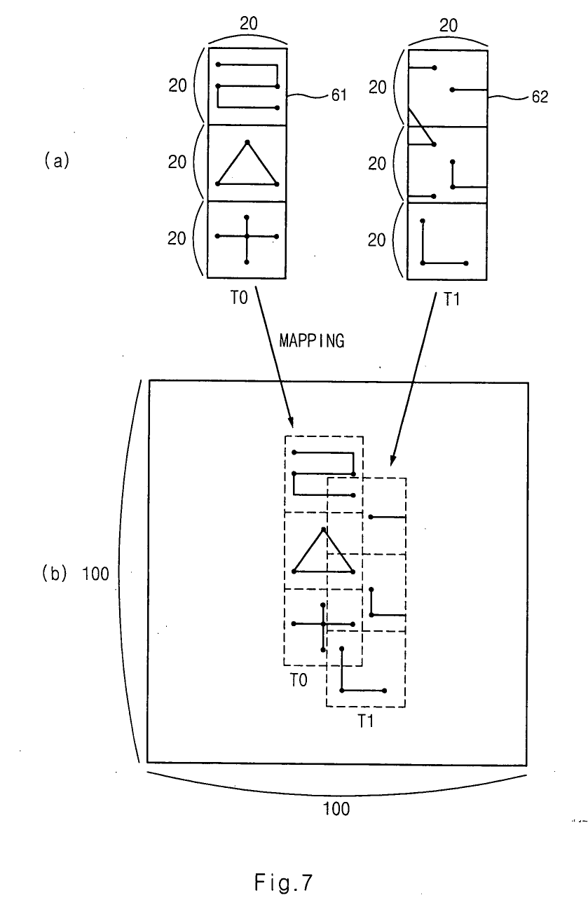

FIG. 7 is a diagram illustrating a process of mapping fingerprint images acquired from the plurality of fingerprint acquiring means 24-1, 2, 3 shown in FIG. 6.

FIG. 7 shows the process of acquiring a fingerprint image of about 20×20 pixels with 3 microminiaturized fingerprint acquiring means and then acquiring a fingerprint image having a size (about 100×100 pixels) required in user recognition using the fingerprint image of about 20×20 pixels. FIG. 7a shows the fingerprint image of 20×20 pixels acquired by the fingerprint acquiring means 24-1, 2, 3 depending on the previously set cycle. FIG. 7b shows the process of mapping the fingerprint images shown in FIG. 7a corresponding to locations of the virtual image space 29 of 100×100 pixels.

When the mapping process of FIG. 7 is compared with that of FIG. 5, the mapping process of FIG. 5 maps one fingerprint image acquired at every time in the virtual image space 29 depending on the set cycle while that of FIG. 7 maps 3 fingerprint images acquired at every time in the virtual image space 29 depending on a predetermined cycle.

Referring to FIGS. 7a and 7b, the fingerprint acquiring means 24-1, 2, 3 simultaneously acquire 3 fingerprint images of 20×20 pixels (first fingerprint image set 61) at a timing T₀. Next, the characteristic point extracting means 25 extracts at least one or more characteristic points from the first fingerprint image set 61, and stores the extracted characteristic points in the memory means 26. The characteristic points of the first fingerprint image set 61 in FIG. 7a are all 12 (represented as black spots). The mapping means 28 maps the first fingerprint image set 61 in a specific location of the virtual image space 29. Here, the first fingerprint image set 61 is preferably mapped at the center of the virtual image space 29. Thereafter, the fingerprint acquiring means 24-1, 2, 3 acquire 3 fingerprint images (second fingerprint image set 62) at the next timing T1. The characteristic point extracting means 25 extracts at least one or more characteristic points (number: 9) from the second fingerprint image set 62, and stores the characteristic points in the memory means 26. The movement detecting means 27 calculates displacement data (direction and distance) with movement information of the first fingerprint image set 61 and the second fingerprint image set 62. The displacement data are calculated by the same method described in FIG. 4. The mapping means 28 maps the second fingerprint image set 62 in locations corresponding to the displacement data calculated by the movement detecting means 27. The mapping operation is repeatedly performed until the whole size of the mapped fingerprint image sets 61, 62, . . . , n becomes a size required in user recognition, that is, the size of the virtual image space 29. As a result, the fingerprint image having a large size required in the user recognition can be obtained with a plurality of fingerprint images each having a small size. Here, the second fingerprint image set 62 includes fingerprint images obtained from the 3 fingerprint acquiring means 24-1, 2, 3 by moving a finger for a predetermined time T₁-T₀ after acquisition of the first fingerprint image set 61.

Here, as described in FIG. 5, when the fingerprint image sets acquired at the current cycle are mapped in the virtual image space 29, it is preferable to map characteristic points so that a part of characteristic points of the fingerprint image set acquired at the current cycle may be superposed with that of characteristic points of the fingerprint image acquired at the previous cycle.

The recognizing means 30 determined identification by comparing the previously registered fingerprint image with the whole fingerprint image mapped in the virtual image space 29 when the fingerprint image sets are mapped in the entire virtual image space 29. The recognizing means 30 certifies a user when the two fingerprint images are identical, but refuses the user certification if not.

Meanwhile, the pointing device according to an embodiment of the present invention controls a pointer with movement of fingerprint images acquired from the finger surface. The pointing process in the pointing device is described as follows. The operations of the light emitting means 22, the light gathering means 23, the fingerprint acquiring means 24, the characteristic point extracting means 25, the memory means 26 and the movement detecting means 27 are the same as described above. However, when a pointing function is performed, the operating means 31 receives displacement data on characteristic points of fingerprint images or fingerprint image sets calculated in the movement detecting means 27, and calculates a direction and a distance where the pointer is to move on a monitor with the displacement data. That is, as shown in FIG. 4, the operating means 31 calculates a desired direction and a desired distance where the pointer is to move. Here, although the movement detecting means 27 calculates displacement data with characteristic points of the acquired fingerprint image, displacement data can be directly calculated with digital fingerprint image data.

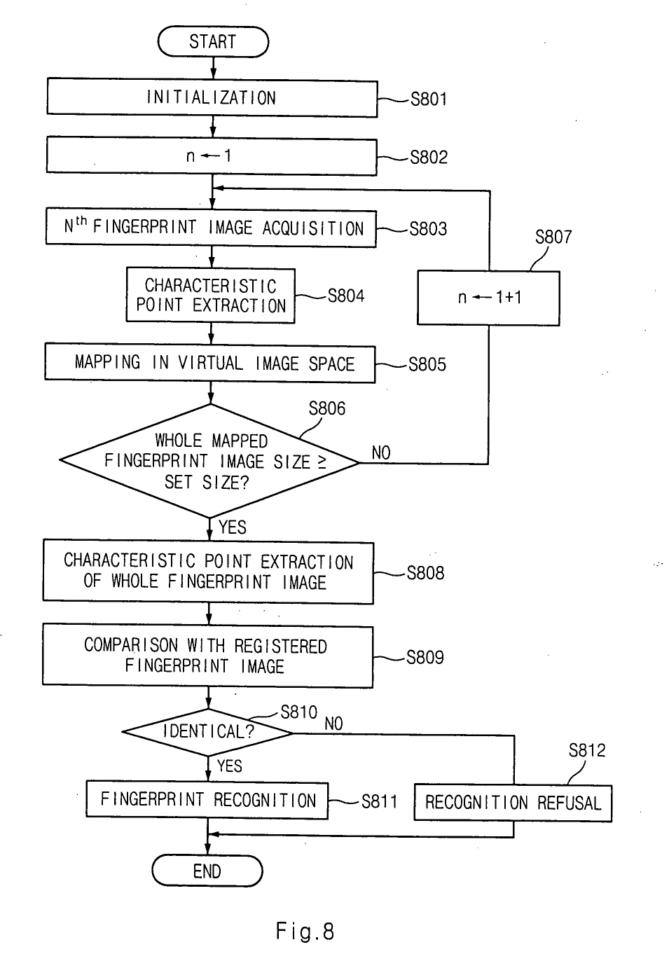

FIG. 8 is a flow chart illustrating a fingerprint recognition process in a pointing device according to the first or the second embodiment of the present invention.

If n ix set to be 1 (S802) after the pointing device is initialized (S801), each of the fingerprint acquiring means 24, 24-1, 2, 3 acquires n (n=1)th fingerprint image of 20×20 pixels (S803). Here, when the plurality of fingerprint acquiring means 24-1, 2, 3 are used as shown in FIG. 6, the pointing device can acquire a plurality of fingerprint images (fingerprint image set) at the same time. As a result, although the size of the fingerprint image acquired from the respective fingerprint acquiring means at every time is about 20×20 pixels, the whole size of the fingerprint image acquired at every time can be adjusted by controlling the number of fingerprint acquiring means.

The characteristic point extracting means 25 extracts at least one or more characteristic points from the n fingerprint image acquired by the fingerprint acquiring means 24, 24-1, 2, 3, and stores the characteristic points in the memory means 26 (S804).

Next, the mapping means 28 maps the n fingerprint image in the virtual image space 29 with the extracted characteristic points (S805).

The recognizing means 30 identifies whether the size of the whole fingerprint image mapped in the virtual image space 29 becomes a previously set size (S806). Here, the set size represents the minimum size required in user recognition. That is, although each fingerprint image acquired from the respective fingerprint acquiring means 24, 24-1, 2, 3 has the size of about 20×20 pixels, the size of the fingerprint image is sufficient to obtain movement information of fingerprint images but insufficient to obtain information for user recognition. That is, the fingerprint image of 20×20 pixels is sufficient to obtain movement information of the fingerprint image, but a fingerprint image of about 100×100 pixels is required for user recognition through the fingerprint image. As a result, the set size of the fingerprint image is about 100×100 pixels, which is the size of the virtual image space 29.

If the size of the whole fingerprint image mapped in the virtual image space 29 is smaller than the previously set size, that is, the size of the virtual image space 29, in the step S806, a variable n is increased by 1 (S807) and then fingerprint images are continuously obtained (S803˜S806). The fingerprint image acquiring process continues until the size of the whole fingerprint image mapped in the virtual image space 29 reaches the previously set size.

When the size of the whole fingerprint image mapped in the virtual image space 29 reaches the previously set size in the step S806, the recognizing means 30 extracts at least one or more characteristic points from the whole fingerprint image mapped in the virtual image space 29 (S808).

The recognizing means 30 compares characteristic points of the previously registered fingerprint image with those of the whole fingerprint image extracted in the step S808 (S809).

The recognizing means 30 determines whether the characteristic points compared in the step S808 are identical or not (S810), and the recognizing means 30 certifies a user if the characteristic points are identical (S811) but refuses user certification if not (S812).

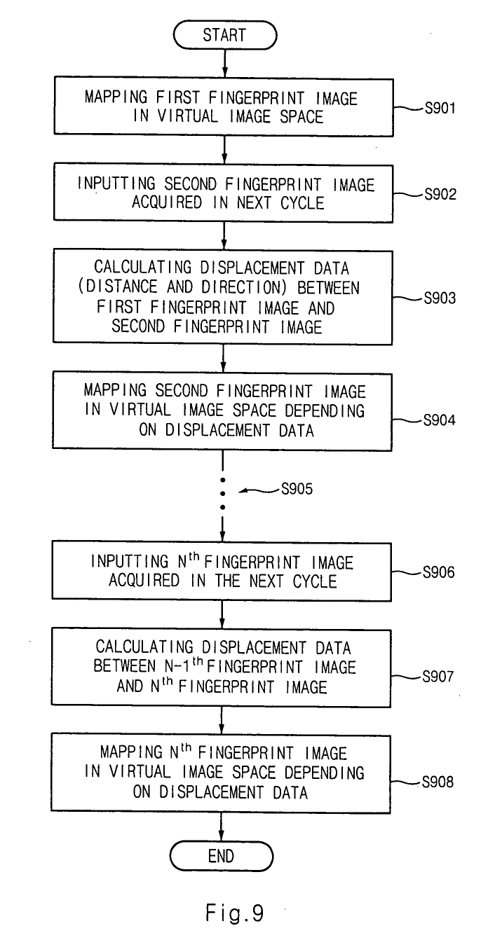

FIG. 9 is a detailed flow chart illustrating the process of mapping a fingerprint image in a virtual image space (S805) in FIG. 8.

First, the first fingerprint image is mapped in a specific location of the virtual image space 29 (S901). Here, the first fingerprint image (or fingerprint image set) is preferably mapped at the center of the virtual image space 29.

Then, when the second fingerprint image is obtained by the fingerprint acquiring means 24, 24-1, 2, 3 in the next cycle, the movement detecting means 27 receives the second fingerprint image (S902) to calculate displacement data (distance and direction) of the second fingerprint image from the first fingerprint image (S903). Here, the second fingerprint image is a fingerprint image obtained with a predetermined time interval depending on movement of the fingerprint. The displacement data of the step S903 are calculated with movement information of the characteristic points of the first fingerprint image and the second fingerprint image. Thereafter, the mapping means 28 maps the second fingerprint image in a corresponding location of the virtual image space 29 depending on the displacement data calculated by the movement detecting means 27 (S904).

The fingerprint acquisition, the displacement data calculation and the mapping operation are continuously performed n times until the size of the whole fingerprint image reaches the previously set size, that is, the size of the virtual image space 29 (S905 S908).

As shown in FIGS. 8 and 9, fingerprint images of about 20×20 pixels acquired n times depending on the set cycle are synthesized into a large fingerprint image to have a size required in user recognition, for example, about 100×100 pixels. The image having the size required in user recognition can be obtained by synthesizing fingerprint images acquired in each location and their relative movement information.

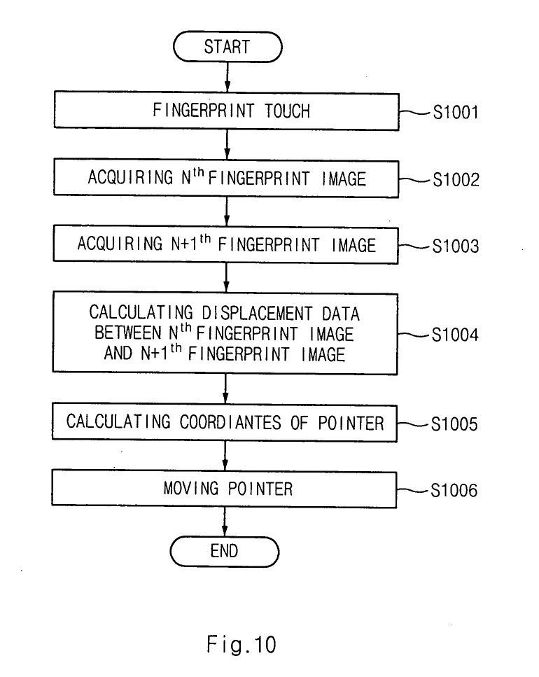

FIG. 10 is a flow chart illustrating a process of controlling a pointer in a pointing device according to the present invention.

If the finger 20 touches on the transparent member 21 (S1001), the n^{th} fingerprint image is obtained by the fingerprint acquiring means 24, 24-1, 2, 3 (S1002). Then, the (n+1)^{th} fingerprint image is obtained by the fingerprint acquiring means 24, 24-1, 2, 3 depending on the previously set cycle (S1003). The movement detecting means 27 calculates the degree of movement from the n^{th} fingerprint image to the (n+1)^{th} fingerprint image, that is, displacement data (S1004). The operating means 31 operates coordinate values of the pointer with displacement data, that is, direction and distance of movement (S1005). Next, a processor (not shown) combined with the operating means 31 moves the pointer corresponding to the coordinates values of the pointer calculated by the operating means 31 (S1006).

In this way, in FIGS. 3 and 6, the pointing device maps a plurality of fingerprint images each having a size suitable for pointer control and acquired by the fingerprint acquiring means 24, 24-1, 2, 3, and extends to have a size suitable for user recognition. As a result, the user recognition and the pointer control can be simultaneously performed with one kind of fingerprint recognizing sensor.

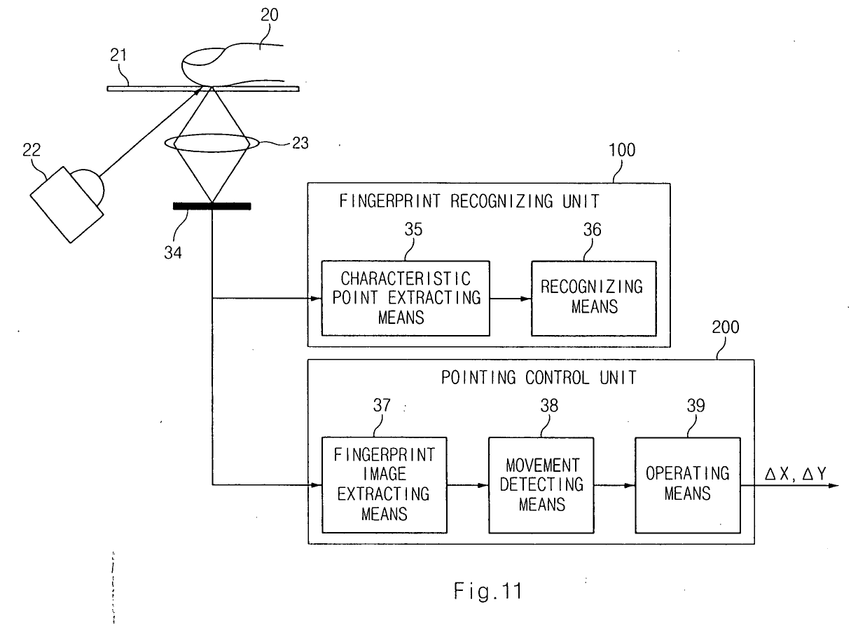

FIG. 11 is a diagram illustrating a structure of a pointing device according to a third embodiment of the present invention.

The pointing device of FIG. 11 comprises a light emitting means 22, a light gathering means 23, a fingerprint acquiring means 34, a fingerprint recognizing unit 100 and a pointing control unit 200.

The fingerprint recognizing unit 100 comprises a characteristic point extracting means 35 and a recognizing means 36, and the pointing control unit 200 comprises a fingerprint image extracting means 37, a movement detecting means 38 and an operating means 39. Here, the pointing device according to an embodiment of the present invention may further comprises a housing (not shown) including the light emitting means 22, the light gathering means 23, the fingerprint acquiring means 34, the characteristic point extracting means 35, the movement detecting means 38 and the operating means 39, and comprising a transparent member 21 where a finger surface touches apart from the fingerprint acquiring means 34 at a predetermined distance. More preferably, the pointing device of FIG. 11 is suitably mounted in a portable terminal device.

In the pointing device of FIG. 11, when the finger 20 touches the transparent member 21, the light emitting means 22 emits light to the surface of the finger 20. The light emitting means 22 includes at least one or more light emitting diodes (abbreviated as “LED”).

The light gathering means 23 condenses light reflected from the surface of the finger 20 after the light is emitted from the light emitting means 22 to the finger 20. A common optical convex can be used as the light gathering means 23.

The fingerprint acquiring means 34 acquires a fingerprint image of a finger surface for controlling a pointer with light condensed through the light gathering means 23. The fingerprint acquiring means 34 converts the analog fingerprint image condensed by the light gathering means 23 into a digital fingerprint image to obtain a fingerprint image of M×N pixels. Here, the size of M×N pixels acquired by the fingerprint acquiring means 34 represents a size required in the user recognition. That is, the size of M×N pixels represents a size to perform a user recognition on the fingerprint image by using the fingerprint image acquired one time. The fingerprint acquiring means 34 includes an optical sensor array where a plurality of CMOS image sensors (abbreviated as “CIS”) are arranged two-dimensionally. Here, the fingerprint acquiring means 34 acquires fingerprint images in the previously set cycle. The fingerprint acquiring means 34 is manufactured to be suitable for a mini-portable device, and the CIS for acquiring a large fingerprint image of over about 100×100 pixels is used. In this way, as the fingerprint acquiring means 34 for user recognition, the CIS can be used which acquires a fingerprint image having various sizes generally ranging from 90×90 pixels to 400×400 pixels. Accordingly, the size of the fingerprint image acquired by the fingerprint acquiring means 34 of the third embodiment of the present invention is different from that of the fingerprint image acquired by the fingerprint acquiring means 24 of the first or the second embodiment of the present invention.

The light generated from the light emitting means 22 is mirrored on the surface of the finger 20, and reflected depending on patterns of the finger 20 surface. The light reflected from the bottom surface of the finger forms a phase in the fingerprint acquiring means 34 through the light gathering means 23. The phase formed in the fingerprint acquiring means 34 is converted into a digital fingerprint image by the fingerprint acquiring means 34. Such fingerprint image acquisition is continuously performed at a rapid speed on a time axis.

The fingerprint recognizing unit 100 extracts characteristic points from the fingerprint image acquired from the fingerprint acquiring means 34 in an operating cycle different from that of the fingerprint acquiring means 34, and performs a user recognition by comparing the extracted characteristic points with those of the previously registered fingerprint image. The fingerprint recognizing unit 100 generally compares the extracted characteristic points with those of the previously registered fingerprint image one to three times per second. That is, the fingerprint recognition process for user certification is performed by receiving 1˜3 fingerprint images per second, extracting characteristic points from the received fingerprint images and comparing the extracted characteristic points with those of the previously registered fingerprint image. More preferably, the processing of the fingerprint recognition is performed at every second. The fingerprint recognition unit 100 comprises the characteristic point extracting means 35 for extracting characteristic points from the acquired fingerprint image and the recognizing means 36 for performing the user recognition by comparing characteristic points of the previously registered fingerprint image with those extracted by the characteristic point extracting means 35.

The pointing control unit 200 extracts a fingerprint image of m×n pixels (M, N>m, n) from the fingerprint image acquired from the fingerprint acquiring means 34 in an operating cycle different from that of the fingerprint recognizing unit 100 to detect movement information of the fingerprint image. The pointing control unit 200 calculates displacement data with the detected movement information, and calculates a direction and a distance where the pointer is to move with the calculated displacement data. Preferably, the pointing control unit 200 detects movement information of characteristic points of the fingerprint image, and calculates displacement data of the characteristic points depending on the movement information. The pointing control unit 200 calculates the movement direction and distance of the pointer corresponding to the displacement data of the characteristic points.

The pointing control unit 200 extracts a fingerprint image of about 20×20 pixels from the fingerprint image acquired in the previous set cycle, calculates displacement data of each fingerprint image and then calculates 2-dimensional coordinates (ΔX, ΔY), that is, a 2-dimensional direction and distance where the pointer is to move with the displacement data. The pointing control unit 200 extracts fingerprint images 800˜1200 times about per second, and calculates displacement data of each fingerprint image extracted depending on the corresponding cycle.

The fingerprint recognizing unit 100 and the pointing control unit 200 individually operates depending on different operating cycles, respectively, to perform the user recognition and the pointer control operation. That is, while a user of the pointing device controls the pointer with the fingerprint image, the fingerprint recognizing unit 100 performs a fingerprint certification on the user independently of the pointing control process. As a result, the fingerprint certification is periodically performed during navigation for the pointer control without an additional fingerprint recognizing process.

Hereinafter, the operations of the fingerprint recognizing unit 100 and the pointing control unit 200 are described in detail.

The characteristic point extracting means 35 extracts at least one or more characteristic points from the fingerprint images acquired at every time depending on the previously set cycle. These characteristic points includes a length, a direction of a fingerprint ridge and location data where the ridge is separated or ended.

The recognizing means 36 compares characteristic points of the previously registered fingerprint image with those extracted from the characteristic point extracting means 35 to perform the user recognition depending on identification of the two fingerprint images. Here, the recognizing means 36 may include a comparing means (not shown) for combining global information and local characteristic information of the acquired fingerprint image and the previously registered fingerprint image or comparing the two fingerprint images with characteristic point matching on the two fingerprint images. The recognizing means 36 determines identification of the two fingerprint images with the comparing means.

The recognizing means 36 performs a user recognition if characteristic points of the previously registered fingerprint image are identical with those extracted from the characteristic point extracting means 35, or refuses the user recognition if not.

The fingerprint image extracting means 37 extracts a fingerprint image of m×n pixels (here, M, N>m, n) from the fingerprint image of M×N pixels acquired from the fingerprint acquiring means 34. The size of m×n pixels represents a size used in pointer control. The size of 20×20 pixels for the pointer control in the pointing device is sufficient for the fingerprint image to generally extract a small fingerprint image. The fingerprint image extracting means 37 extracts fingerprint images ranging from about 15×15 pixels to about 80×80 pixels. As a result, the fingerprint image extracting means 37 extracts a fingerprint image of about 20×20 pixels for the pointer control from the fingerprint image of about 100×100 pixels acquired from the fingerprint acquiring means 34 for the user recognition. Here, the size of the used fingerprint image is just an example of the present invention. That is, the acquired size of M×N pixels is preferably suitable for the user recognition, and the extracted size of m×n pixels is preferably suitable for the pointer control.

The movement detecting means 38 grasps the degree of movement of each fingerprint image acquired at every time depending on the set cycle. Here, the movement detecting means 38 preferably detects the degree of movement of the fingerprint with a motion estimation method by calculating displacement data (direction and distance) on characteristic points of the fingerprint images acquired in the set cycle. More preferably, the movement detecting means 38 detects the degree of movement of the fingerprint image by calculating displacement data on characteristic points of the fingerprint images acquired in the set cycle. Here, the displacement data of the fingerprint image are calculated by calculating movement distance and direction on characteristic points of the fingerprint image acquired in the current cycle from those of the fingerprint image acquired in the previous cycle. The movement information of the fingerprint image and the characteristic point extraction in the fingerprint recognition as well as the fingerprint acquisition are importance factors because the movement of fingerprint images and the reliability of the fingerprint recognition are differentiated depending on how reliably characteristic points can be extracted.

The operating means 39 receives movement degree of the fingerprint image from the movement detecting means 38, that is, displacement data, and calculates 2-dimensional coordinates (ΔX, ΔY), that is, direction and distance/movement degree where the pointer is to move with the received displacement data.

The operating means 39 is generally combined with a pointing device or with a processor of apparatus having the pointing device. As a result, the processor can control the movement of the pointer on a screen of a display device depending on the coordinates calculated in the operating means 39.

The pointing device according to an embodiment of the present invention may further comprise a display means (not shown) for displaying the previously stored information. In this way, when the pointing device further comprises the display means, the display means receives signals depending on the fingerprint recognition of the fingerprint recognizing unit 100 to display the recognition result. When the recognition on the user is successfully performed in the fingerprint recognizing unit 100, information for performing all functions of the corresponding terminals are displayed on the display means. However, when the user recognition is refused, restrictive information is displayed which can perform only a specific function of the terminal.

The technology of restrictively allowing usage of the corresponding terminal through the user recognition will be mentioned later.

The fingerprint acquiring means 34 in the third embodiment of the present invention can be embodied with a semiconductor device as shown in the first and the second embodiments of the present invention.

Meanwhile, when the fingerprint acquiring means 34 is embodied with an optical system, a large fingerprint image for user recognition can be obtained with a mini-fingerprint acquiring means, that is, ‘reduced optical system’. In other words, the size of the fingerprint acquiring means 34 can be miniaturized by reducing the size of the actual fingerprint by ½˜¼ and acquiring the reduced fingerprint image.

The principle and the process of acquiring a fingerprint image with the reduced optical system are described in detail.

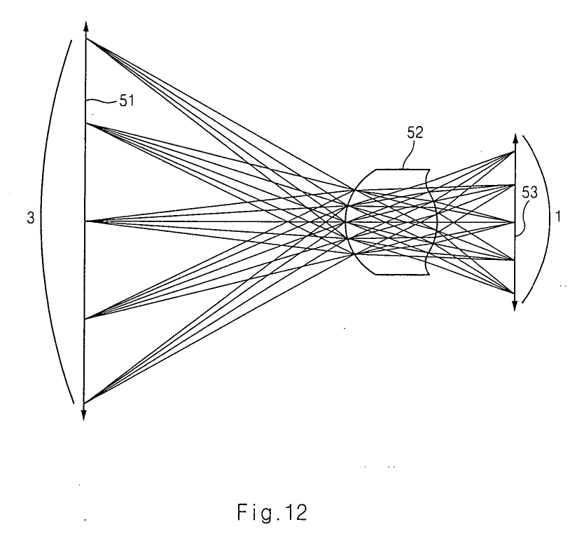

FIG. 12 is a diagram illustrating a design example of 3:1 reduction optics mountable in a microscopic space according to the present invention. As shown in FIG. 12, aspherics 42 are used to mount the optical device in the microscopic space. If the optical system is configured as shown in FIG. 12, the size of the actual object represented by a left arrow 41 is reduced to about a ⅓ size represented by a right arrow 43. If an image of the object represented by the left arrow 41 passes through the aspherics 42, an inverse image is formed with about a ⅓ size in the fingerprint acquiring means 34 located at the right side. The reduced optical system is embodied by application the above-described principle so that the size of the actual fingerprint is reduced to the size of 1/n (here, n is a real number ranging from 1 to 5.

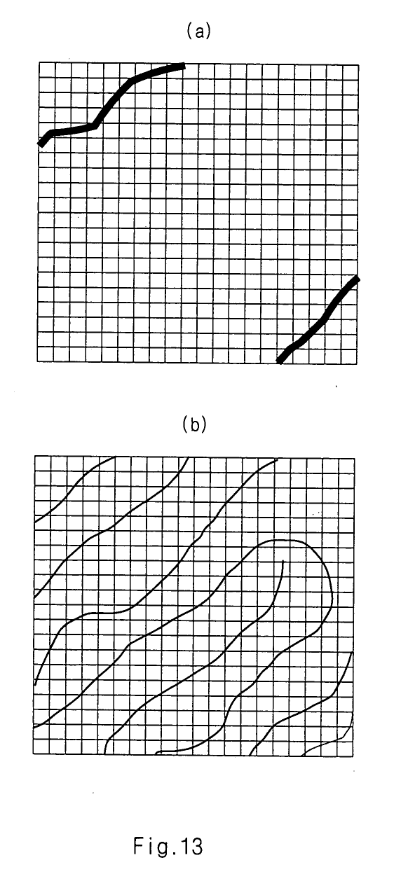

FIG. 13 is a diagram illustrating an example of a fingerprint image acquired from a fingerprint acquiring means by applying the reduction optic system of FIG. 12. FIG. 13a shows a fingerprint image acquired from the fingerprint acquiring means 34 at the optical system of 1:1, and FIG. 13b shows a fingerprint image acquired from the fingerprint acquiring means 34 at the reduced optical system of 4:1.

Generally, about 2 valleys are formed at every 1 mm in a human fingerprint. As a result, a recognition pixel of the fingerprint acquiring means 34 is 0.5 mm, and the number of the fingerprint acquired by the fingerprint acquiring means 34 is just 2, as shown in FIG. 13a, when the fingerprint acquiring means 34 of 20×20 pixels is used. In this way, as the acquired number of valleys of the fingerprint image becomes smaller, the accuracy is degraded in user recognition and the performance can be also degraded in pointer control. As a result, the size of the sensor is required to be larger for sufficient data collection.

In order to overcome the above-described problem, much more data can be obtained by applying the reduced optical system to the fingerprint acquiring means 34 without enlarging the size of the sensor. That is, in the embodiment of the present invention, the size of the fingerprint having an interval 0.5 mm is acquired by reducing the size of the fingerprint by 1/n (here, n is a real number ranging from 1 to 5). More specifically, the size of the fingerprint is reduced to the size of ½˜¼. As a result, much more data can be obtained with the fingerprint acquiring means 34 having the same size of that in FIG. 13a than in FIG. 13a. As shown in FIG. 13b, when the size of the fingerprint is reduced to the size of ¼ with the reduced optical system, the fingerprint interval of 0.5 mm can be reduced to about 0.125 mm. Therefore, 4˜16 times fingerprint information can be obtained with the fingerprint acquiring means 34 having the same size in comparison with FIG. 13a. In other words, when a fingerprint image is obtained by reducing a fingerprint having an average interval of 0.5 mm to a ½˜¼ size, the size of the fingerprint acquiring means 34 can be miniaturized to ¼˜ 1/16. As a result, it is possible to obtain a fingerprint image for user recognition and pointer control with the miniaturized fingerprint acquiring means 34 of low power consumption and low cost, and the miniaturized fingerprint acquiring means 34 is advantageous in application to a mini-portable terminal device.

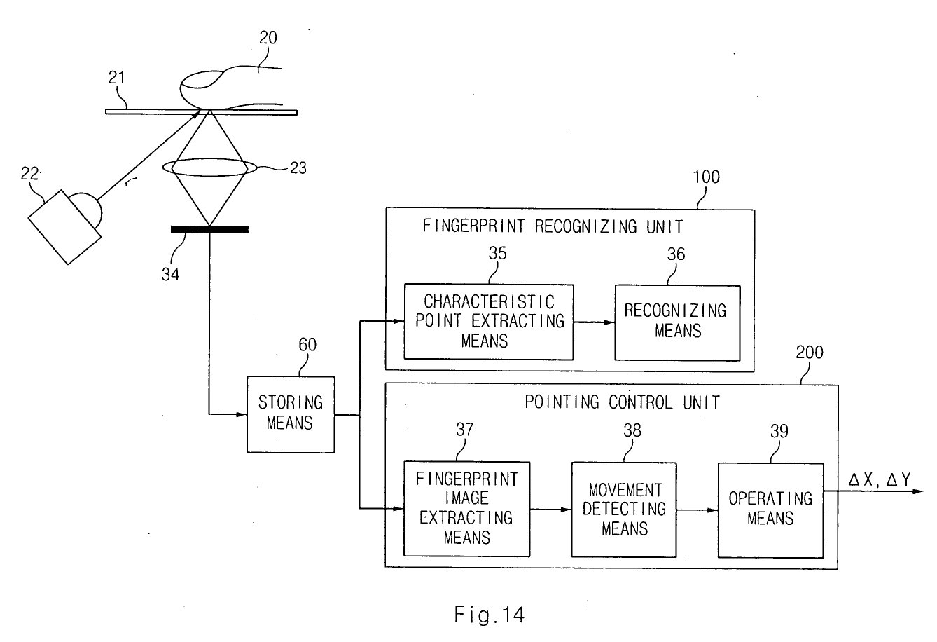

FIG. 14 is a diagram illustrating a pointing device having a fingerprint recognizing function according to a fourth embodiment of the present invention.

The pointing device of FIG. 14 further comprises a storing means 60 in comparison with that of FIG. 11. The storing means 60 stores fingerprint images acquired from the fingerprint acquiring means 34. In the pointing device of FIG. 14, if the fingerprint images acquired from the fingerprint acquiring means 34 at every time depending on the previously set cycle are stored in the storing means 60, the fingerprint recognizing unit 100 and the pointing control unit 200 individually perform a user recognition and a pointer control with the fingerprint images stored in the storing means 60. That is, while the user recognition and the pointer control are performed in the fingerprint recognizing unit 100 and the pointing control unit 200, respectively, which immediately receive the fingerprint images acquired depending on the operating cycle of the fingerprint acquiring means 34 in the pointing device of FIG. 11, the fingerprint images acquired from the fingerprint acquiring means 34 are first stored in the storing means 60 and then the pointer control is performed only with the fingerprint image having a size required in the pointer control so that the pointer may be embodied with low cost, low power consumption and high-speed navigation information production. Here, it is natural to simultaneously perform the user recognition and the pointer control with the fingerprint images stored in the storing means 60.

In this way, the user recognition and the pointer control can be simultaneously performed with one kind of fingerprint recognizing sensors by extracting a fingerprint image having a size required in the pointer control from the fingerprint images acquired from the fingerprint acquiring means 34 for the user recognition in the pointing devices of FIGS. 11 and 14.

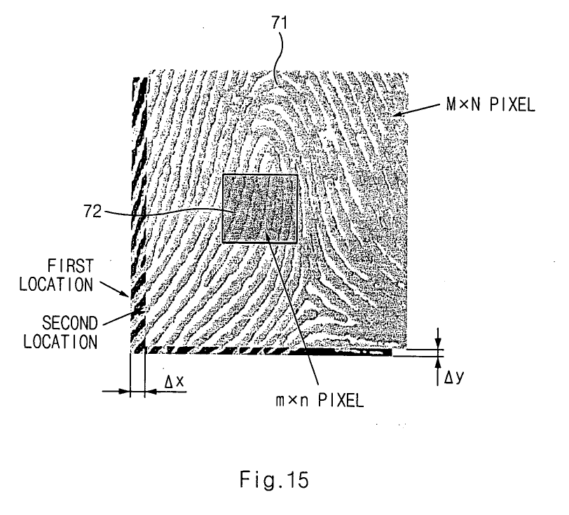

FIG. 15 is a diagram illustrating a method for extracting a fingerprint image of m×n pixels from that of M×N pixels.

The fingerprint acquiring means 34 acquires a fingerprint image 71 of M×N pixels depending on a predetermined cycle. The fingerprint image 71 of M×N pixels has a sufficient size for user recognition. Preferably, the fingerprint image 71 has a size ranging from 90×90 pixels to 400×400 pixels. Also, the fingerprint image extracting means 37 extracts a fingerprint image 72 of m×n pixels from the fingerprint image 71 of M×N pixels. Here, the fingerprint image extracting means 37 extracts a central portion of the fingerprint image 71 of M×N pixels. The size of m×n pixels represents the size of the fingerprint image 72 where the pointer control is possible. The fingerprint image 72 has a size ranging from 15×15 pixels to 80×80 pixels.

In the pointing device of FIG. 14, the fingerprint image 71 of M×N pixels is stored in the storing means 60, and the user recognition is performed with the fingerprint image 71 of M×N pixels. At the same time, the pointer control is performed with the fingerprint image 72 of m×n pixels extracted from the fingerprint image 71 of M×N pixels.

In case that the pointer is regulated with the fingerprint image 72 of m×n pixels, when the surface of the finger 20 moves from a first location to a second location by ΔX and ΔY, data on the fingerprint image of m×n pixels extracted from the fingerprint image extracting means 37 are transmitted to the movement detecting means 38. Here, the fingerprint image is transmitted at a speed of about 800˜1200 times per second. As a result, displacement data of the fingerprint image depending on movement of the finger 20 are calculated and converted to the speed, and the movement direction and distance of the pointer are also calculated and converted to the speed. Here, since the above-described processing speed is required for a stable pointing operation in the pointing device according to an embodiment of the present invention, it is preferable to select the minimum image size in order to reduce the processing and calculation amount.

Meanwhile, the whole fingerprint image 71 of M×N pixels required for the user recognition is transmitted to the fingerprint recognizing unit 100. The fingerprint image 71 is transmitted at a speed of 1˜3 times per second where a general recognition processing can be performed. The fingerprint recognizing unit 100 is configured to be included in a processing device of the portable terminal device so that the fingerprint recognizing unit 100 can perform the function.

The process of calculating the displacement data of the fingerprint image 72 with the characteristic points of the fingerprint image 72 is the same as that of FIG. 4.

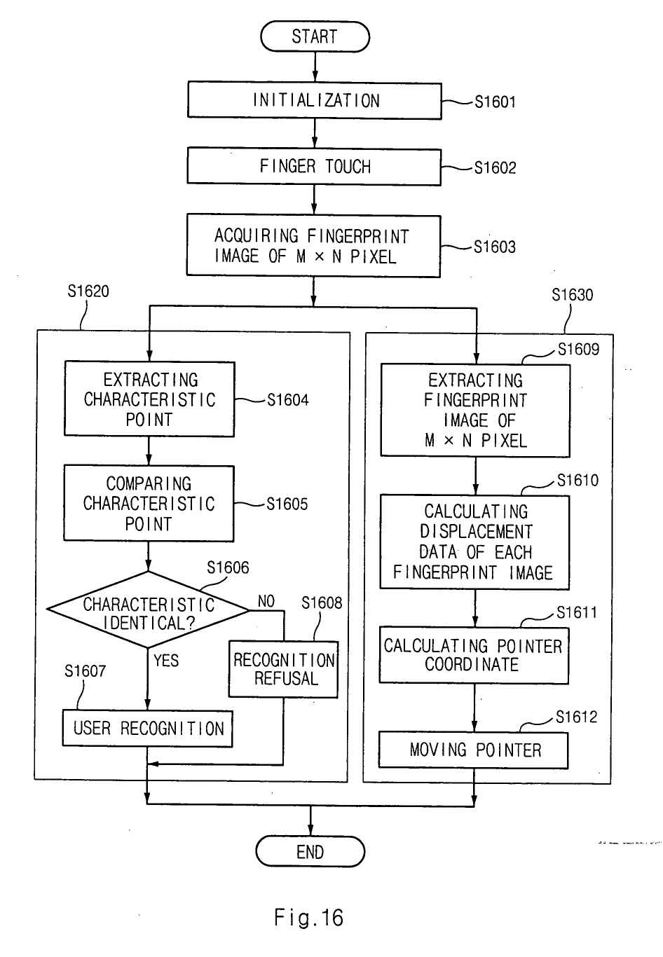

FIG. 16 is a flow chart illustrating a method for performing a user recognition and a pointing control at the same time according to the third or the fourth embodiment of the present invention.

At the initialization state (S1601), if the surface of the finger 20 touches the transparent member 21 (S1602), the fingerprint image of M×N pixels is obtained by the fingerprint acquiring means 34 depending a first operating cycle (S1603).

The fingerprint recognizing unit 100 and the pointing control unit 200 simultaneously perform the user recognition (S1620) and the pointer control (S1630) with the fingerprint image 71 obtained by the fingerprint acquiring means 34. In case of the pointing device of FIG. 14, the user recognition (S1620) and the pointer control (S1630) are the same as those of the pointing device of FIG. 11 except in that the obtained fingerprint image 71 is stored in the storing means 60 and the fingerprint image 61 stored in the storing means 60 is used.

In the user recognition process (S1620), the characteristic point extracting means 35 extracts at least one or more characteristic points from the fingerprint image of M×N pixels depending on a second operating cycle to transmit the characteristic points to the recognizing means 36 (S1604). The recognizing means 36 compares the characteristic points of the previously registered fingerprint image with those extracted from the fingerprint image of M×N pixels (S1605). The recognizing means 36 determines whether the characteristic points of the two fingerprint images are identical from the comparison result (S1606). The recognizing means 36 certifies a user (S1607) if the characteristic points of the two fingerprint images are identical, and refuses the user recognition (S1608) if not.

Next, in the pointer control process (S1630), the fingerprint image extracting means 37 extracts the fingerprint image 72 of m×n pixels from the fingerprint image of M×N pixels depending on a third cycle to transmit the extracted fingerprint image to the movement detecting means 38 (S1609). In the embodiment, m and n ranges from 15 to 80 to have a size suitable for the pointer control of the extracted fingerprint image 72. The movement detecting means 38 calculates displacement data of the fingerprint images 72 of m×n pixels to transmit the displacement data to the operating means 39 (S1610). Here, the movement detecting means 38 calculates displacement data by calculating movement degree, that is, distance and direction, of the fingerprint image acquired in the current cycle from that acquired in the previously cycle. Preferably, the displacement data depending on the movement degree of characteristic points of the extracted fingerprint images 72 are calculated. The operating means 39 operates coordinates where the pointer is to move with the displacement data calculated in the movement extracting means 38 (S1611). A processor (not shown) of the terminal device moves the pointer corresponding to the coordinates of the pointer (S1612).

As described in FIG. 16, the pointing device according to the embodiment of the present invention can simultaneously perform the user recognition and the pointer control by using the fingerprint image 71 acquired from one fingerprint acquiring sensor 34. The user recognizing process (S1620) and the pointer control process (S1630) are performed on different operating cycles which are previously set, and the two process S1620 and S1630 are individually perform. That is, while a user regulates the pointer with the fingerprint (S1630), the user recognition process (S1620) is naturally performed. As a result, the fingerprint recognizing process is not required to a user, and the fingerprint is automatically recognized during the pointer control so that the range of service available by users can be regulated to the corresponding device depending on the fingerprint recognizing result.

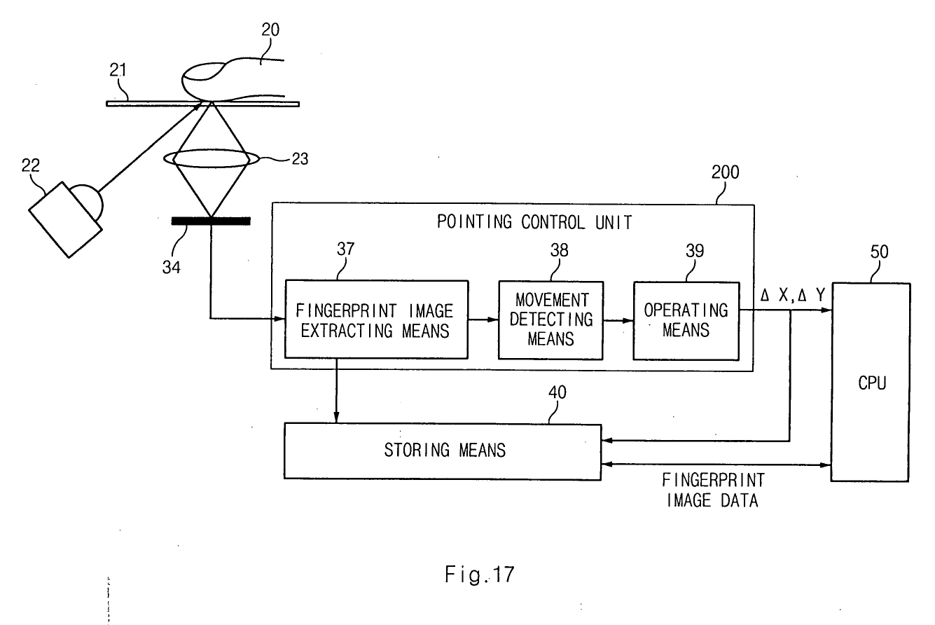

FIG. 17 is a diagram illustrating a structure of a pointing device according to a fifth embodiment of the present invention.

In comparison with the above-described embodiments of the present invention, the fifth embodiment is characterized in that the process is not comprised to extract characteristic points from the fingerprint image during the fingerprint recognizing function. That is, a location where the acquired fingerprint image is stored in the storing means depending on the extracted characteristic points is not determined. Instead, a mapping location of the fingerprint image is determined depending on movement distance, that is, displacement data, and stored in the storing means.

Hereinafter, the configuration of the pointing device of FIG. 17 is described in detail.

The pointing device of FIG. 17 comprises a transparent member 21, a light emitting means 22, a light gathering means 23 and a fingerprint acquiring means 34. However, the explanation on the configuration of these elements is omitted because it is the same as that of the third or the fourth embodiment.

The fingerprint image obtained by the fingerprint acquiring means 34 is immediately input into a pointing control unit 200 including a fingerprint image extracting means 37, a movement detecting means 38 and an operating means 39. Since the operation of the detailed elements of the pointing control unit 200 is the same as that described in the third or the fourth embodiment, the specific explanation is omitted.

However, in comparison with the third or the fourth embodiment, the operation of the fifth embodiment is characterized in that the fingerprint image of m×n pixels extracted by the fingerprint image extracting means 37 is stored in the storing means 40 and the storing location is mapped depending on data of displacement values calculated by the operating means 39. Specifically, suppose that the i^{th} fingerprint image extracted from the fingerprint image extracting means 37 is stored in a specific location of the storing means 40. If the (i+1)^{th} fingerprint image is extracted from the fingerprint image extracting means 37, the displacement data ΔX and ΔY obtained through the movement detecting means 38 and the operating means 39 are received, and the (i+1)^{th} fingerprint data are stored in a location moved by the displacement data from the specific location where the i^{th} fingerprint data are stored.

The operation of storing the fingerprint data in the storing means 40 is performed by a method of periodically storing data depending on a predetermined time interval or performed when a specific command is received.

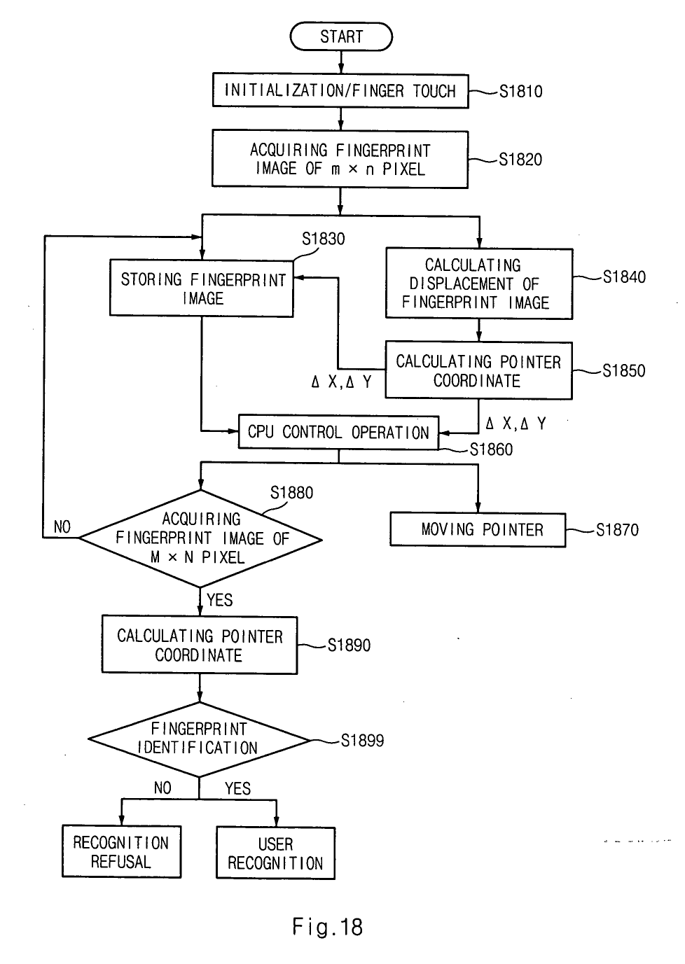

Also the fifth embodiment of the present invention includes a CPU 50 for controlling the operation of storing fingerprint data in the above-described storing means 40, controlling the movement of the pointing device by receiving the displacement data ΔX and ΔY from the operating means 39 and performing the fingerprint recognizing operation described later in FIG. 18.

FIG. 18 is a flow chart illustrating the operation of the pointing device according to the fifth embodiment of the present invention.

If the system is initialized and the surface of the finger 20 touches the transparent member 21 (S1810), the fingerprint image of m×n pixels is acquired by the fingerprint acquiring means 34 and the fingerprint image extracting means 37 (S1820).

The acquired fingerprint image is stored in the storing means 40 (S1830), and the displacement data and the pointer coordinates on the fingerprint image are calculated (S1840, S1850). The calculation result is provided to the storing means 40, and used in mapping the fingerprint image.

The calculation result is also provided to the CPU 50, and used to control the operation of the pointing device (S1860, S1870).

Meanwhile, the CPU 50 receives the fingerprint image from the storing means 40. If the received fingerprint image is not a fingerprint image of M×N pixels, the CPU 50 receives a fingerprint image from the storing means 40 again (S1880). If the received fingerprint image is identical with that of M×N pixels, the fingerprint image is compared with the previously stored fingerprint image (S1890), and identification of the two fingerprint images is determined (S1899). Then, the user recognition or recognition refusal operations are performed depending on the result.

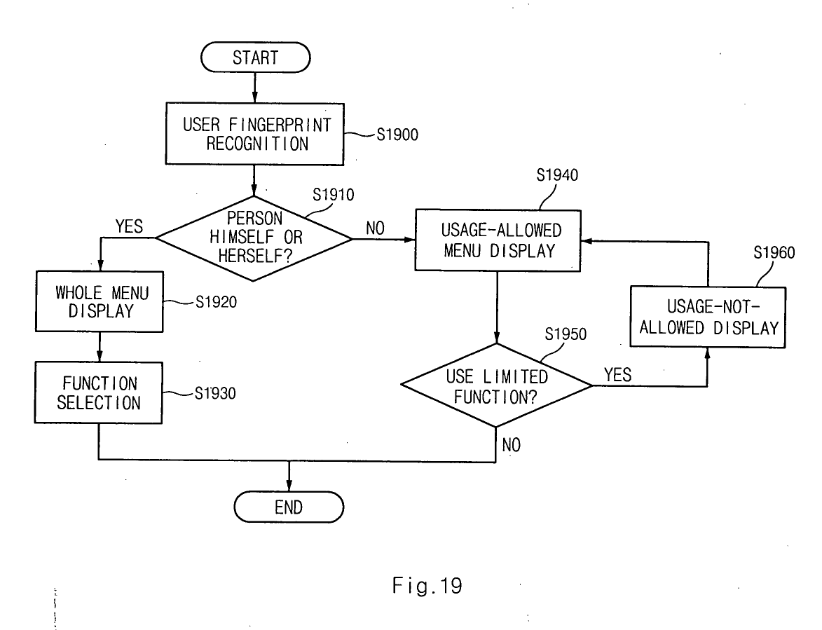

FIG. 19 is a flow chart illustrating a method for limiting usage of a portable communication terminal device depending on users by using a fingerprint recognition function according to the present invention.

In an embodiment, the portable terminal device having a fingerprint recognition function identifies fingerprints of users to perform a fingerprint recognition on the users (S1900). The portable terminal device identifies through the fingerprint recognition whether a person who intends to user the terminal device is the person himself or herself (S1910). When a user is the person himself or herself, the terminal device displays the whole menu that can be provided by the terminal device (S1920) so that the user may use all functions (service) (S1930). However, when the user is not the person himself or herself, the terminal device only displays a specific menu that can allowed to be used by the person himself or herself (S1940). In this way, important information such as credit and finance information can be protected by limiting usage of the terminal device to a person who is not recognized through the fingerprint recognition.

If a user who is not the person himself or herself intends to use functions which are not allowed (S1950), the terminal device displays a message that the corresponding function cannot be used (S1960). Then, after a few seconds, the terminal device displays again a menu whose usage is allowed by the person himself or herself (S1940). Accordingly, in case that a person is not a previously registered user, personal information of the user, control information of the system and pay service such as e-commerce can be protected by limiting access of other users for personal information protection.

The fingerprint identifying process can be operated as a background process in order to relieve inconvenience in usage of the portable communication terminal device. Here, the background process is to automatically perform steps of collection, analysis and identification of data required in fingerprint identification while a user uses a 2-dimensional pointer with a finger of the user without notifying the steps to the user. When the user uses a process previously specified for protection in the system or when an approval transaction is performed, a required process is performed in case of the person himself or herself with data obtained from the background process. However, when the user is not the person himself or herself, the process is refused to protect information or possession of a possessor.

That is, the person identification process is performed in combination with the background process. The next step is successively performed when the user is the person himself or herself, but the subsequent usage is refused when the user is not the person himself or herself. As a result, the necessary stability can be secured without affecting convenience of users. Here, the same sensor of package in fingerprint registration and identification as that of the 2-dimensional pointing device is used, and the pointing device is configured to perform the data collection and the software process at the same time.

In the above-described embodiment, if the person himself or herself registers his or her fingerprint, the registered data are saved in a non-volatile memory and repeatedly used until the person himself or herself changes the data.

In another embodiment of the present invention, not a fingerprint recognition sensor for fingerprint recognition but a pointing device having a fingerprint certifying sensor function can identify through fingerprint identification of users whether a portable terminal device user is the person himself or herself while the user uses the portable communication terminal device. For this operation, the portable terminal device collects 2-dimensional movement information while user moves his or her finger, generates a 2-dimensional image having a size required for the person identification by synthesizing the collected movement information and the fingerprint image in the corresponding location, and extracts characteristic points from the corresponding fingerprint image. Then, the portable terminal device registers the extracted characteristic points or compares the extracted characteristic points with registered data for the person identification.

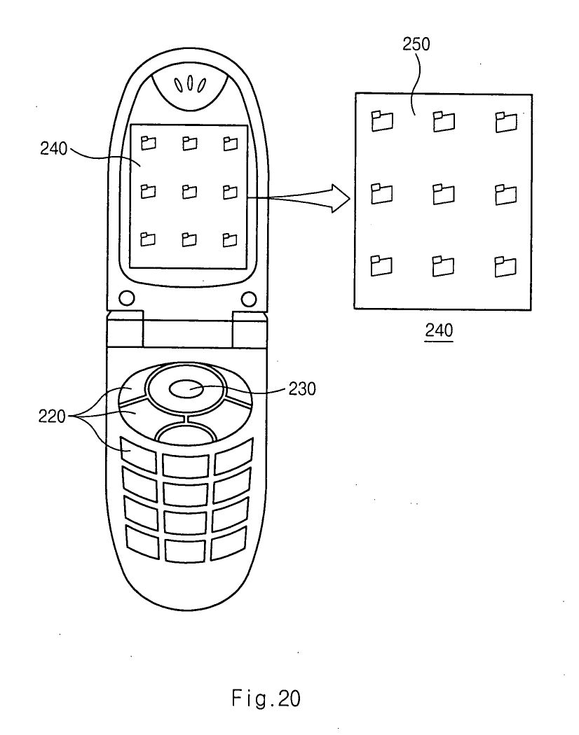

FIG. 20 is a diagram illustrating an example of a portable terminal device comprising a pointing device according to the present invention. The portable terminal device includes a cellular phone, a PDA or a smart phone.

In the portable terminal device, an external surface of a transparent member 230 is exposed, and a fingerprint image having a size required for user recognition is obtained through fingerprint acquisition when a finger is put on the external surface of the transparent member 230. If the fingerprint image is acquired, the existing menu window is changed to a service screen 240 as shown in FIG. 20.

In the portable terminal service, the service can be used by selecting and clicking the menu on the service screen 240 not with a moving key such as a mouse of a general computer but with a pointer 250. Also, the portable terminal device comprises at least one or more function buttons 220 for performing other functions or inputting performance commands.

While the invention is susceptible to various modifications and alternative forms, specific embodiments have been shown by way of example in the drawings and described in detail herein. However, it should be understood that the invention is not limited to the particular forms disclosed. Rather, the invention covers all modifications, equivalents, and alternatives falling within the spirit and scope of the invention as defined in the appended claims.

### INDUSTRIAL APPLICABILITY

In a pointing device having a fingerprint recognition function and a fingerprint recognition method according to an embodiment of the present invention, fingerprint images having small sizes are mapped to generate a large fingerprint image or a small fingerprint image extracted from the large fingerprint image so that the pointing device performs user recognition and pointer control. As a result, respective sensors for the user recognition and for the pointer control are not comprised in the pointing device, but only one kind of sensors for performing both functions of user recognition and pointer control is comprised in the pointing device according to an embodiment of the present invention. Also, it is possible to easily embody miniaturization of a portable terminal device because the user recognition which requires a large fingerprint can be performed only with a small fingerprint image, thereby reducing manufacturing cost.

Additionally, important information in the terminal device can be protected by limiting kinds of service usable in the terminal device depending on user recognition.

1. A pointing device having a fingerprint image recognition, comprising:
at least one or more fingerprint acquiring means for acquiring a fingerprint image of a finger surface depending on a predetermined cycle;
a characteristic point extracting means for extracting at least one or more characteristic points from the acquired fingerprint image;
a movement detecting means for calculating displacement data between characteristic points of the extracted fingerprint image to detect movement information of the fingerprint image;
a mapping means for mapping the fingerprint image in an inner virtual image space depending on the movement information;
a recognizing means for comparing a previously registered fingerprint image with the whole mapped fingerprint image when the entire size of the mapped fingerprint image reaches a previously set size and determining recognition on the fingerprint; and
an operating means for receiving the displacement data from the movement detecting means and calculating a direction and a distance where a pointer is to move with the displacement data.

2. The pointing device according to claim 1, further comprising a housing which includes the fingerprint acquiring means, the characteristic point extracting means, the movement detecting means, the mapping means, the recognizing means and the operating means and comprises a transparent member having a plane surface which the finger surface contacts with at a predetermined distance from the fingerprint acquitting means.

3. The pointing device according to claim 1, wherein the fingerprint acquiring means is a CMOS image sensor.

4. The pointing device according to claim 1, wherein the sizes of the acquired fingerprint image and the virtual image space are m×n pixels and M×N pixels, respectively, and the m and the n are smaller than the M and the N, respectively.

5. The pointing device according to claim 1, wherein the movement detecting means calculates movement distances and directions of the characteristics points of the fingerprint image acquired in the current cycle from those of the fingerprint image acquired in the previous cycle.

6. The pointing device according to claim 1, wherein the mapping means maps a fingerprint image in the virtual image space so that identical characteristic points are superposed when there are the identical characteristic points between characteristic points of the n−1^{th} fingerprint image and the n^{th} fingerprint image.

7. The pointing device according to claim 1, wherein the recognizing means determines whether the characteristic points of the previously registered fingerprint image are identical with those of the whole mapped fingerprint image by matching the characteristic points of the previously registered fingerprint image with those of the whole mapped fingerprint image, and decides recognition of the fingerprint depending on the determination result.

8. A portable terminal device which comprises a pointing device described in claim 1 and performs a fingerprint recognition of a user and a control of the pointer.

9. A method for recognizing a fingerprint for user recognition, comprising the steps of:
a fingerprint image acquiring step for acquiring at least one or more fingerprint images with a predetermined fingerprint acquiring sensor depending on a set cycle;
a characteristic point extracting step for extracting at least one or more characteristic points from the acquired fingerprint image;
a first mapping step for mapping a first fingerprint image in a specific location of a virtual image space;
a displacement data calculating step for calculating displacement data between characteristic points of the first fingerprint image and those of a second fingerprint image acquired in the next cycle after the cycle where the first fingerprint image is acquired;
a second mapping step for mapping the second fingerprint image with the displacement data in the virtual image space; and
a fingerprint recognition step for comparing characteristic points of the previously registered fingerprint image with those of the whole mapped fingerprint image when the whole size of the fingerprint images mapped in the virtual image space reaches a previously set size, and determines recognition of the fingerprint.

10. The method according to claim 9, wherein the sizes of the acquired fingerprint image and the virtual image space are m×n pixels and M×N pixels, respectively, and the m and the n are smaller than the M and the N, respectively.

11. The method according to claim 9, wherein the displacement data calculating step is to calculate movement distances and directions of the characteristic points of the second fingerprint image from those of the first fingerprint image.

12. The method according to claim 9, wherein the second mapping step is to map the second fingerprint image in a location corresponding the calculated displacement data from the first fingerprint image mapped in the virtual image space.

13. The method according to claim 9, wherein the second mapping step is to map the second fingerprint image in the virtual image space so that identical characteristic points are superposed when there are the identical characteristic points between the characteristic points of the first fingerprint image and the second fingerprint image.

14. The method according to claim 9, wherein the fingerprint image acquiring step is to acquire a plurality of fingerprint images at every time with a plurality of fingerprint acquiring sensors.

15. The method according to claim 14, wherein the plurality of acquired fingerprint images are images of the adjacent fingerprints.

16. The method according to claim 9, wherein the fingerprint recognition step comprises: the first step of determining whether the size of the whole fingerprint image mapped in the virtual image space reaches the previously set size; the second step of extracting at least one or more characteristic points from the whole fingerprint images when the whole fingerprint image reaches the previously set size depending on the determination result; the third step of comparing characteristic points of the previously registered fingerprint image with the extracted characteristic points; and the fourth step of determining recognition of the fingerprint depending on the comparison result.

17. A pointing device having a fingerprint recognition, comprising: a fingerprint acquiring means (first operating cycle) for acquiring a required fingerprint image to a finger surface which controls a pointer through only once 2-dimensional image acquisition;
a fingerprint recognizing unit (second operating cycle) for extracting at least one or more characteristic points from the acquired fingerprint image and comparing characteristic points of the previously registered fingerprint image with the extracted characteristic points to recognize a user of the acquired fingerprint image; and
a pointing control unit (third operating cycle) for detecting movement information based on partial data of an image acquired with the first operating cycle and calculating displacement data of the fingerprint image depending on the movement information to calculate movement direction and distance of the pointer.

18. The pointing device according to claim 17, wherein the fingerprint recognizing unit comprises: a characteristic point extracting means for extracting at least one or more characteristic points from the fingerprint image acquired by the fingerprint acquiring means; and a recognizing means for comparing characteristic points of the previously registered fingerprint image with those that are extracted by the characteristic point extracting means to determine recognition of a user of the fingerprint image.

19. The pointing device according to claim 18, wherein the recognizing means determines whether the characteristic points of the previously registered fingerprint image are identical with the extracted characteristic points by matching the characteristic points of the previously registered fingerprint image and the extracted characteristic points, and performs a recognition on the user depending on the determination result.

20. The pointing device according to claim 17, wherein the pointing control unit comprises:
a fingerprint image extracting means for extracting a fingerprint image of m×n pixels (here, m and n are integers) from that of M×N pixels (here, M and N are integers, m<M, n<N) acquired by the fingerprint acquiring means;
a movement detecting means for calculating displacement data of the extracted fingerprint image of m×n pixels to detect movement information of the respective fingerprint image; and an operating means for receiving displacement data from the movement detecting means and calculating movement direction and distance of the pointer based on the displacement data.

21. The pointing device according to claim 20, wherein the movement detecting means calculates the movement direction and distance of the characteristic points of the fingerprint image acquired in the current cycle from those of the fingerprint image acquired in the previous cycle to calculate the displacement data of the fingerprint image.

22. The pointing device according to claim 20, wherein the M and the N range from 90 to 400, and the m and the n range from 15 to 80.

23. The pointing device according to claim 17, wherein the fingerprint acquiring means is a CMOS image sensor.

24. The pointing device according to claim 17, wherein the fingerprint acquiring means is an active capacitive sensor.

25. The pointing device according to claim 17, wherein the second operating cycle is 1˜3 times/second.

26. The pointing device according to claim 17, wherein the third operating cycle is 800˜1200 times/second.

27. The pointing device according to claim 17, wherein the fingerprint recognizing unit and the pointing control unit are individually operated at the same time depending on the second operating cycle and the third operating cycle.

28. The pointing device according to claim 17, further comprising: a light emitting means for emitting light toward the finger surface which controls the pointer; and a light gathering means for condensing the fingerprint image reflected from the finger surface, wherein a fingerprint image condensed by the light gathering means is acquired by the fingerprint acquiring means.

29. The pointing device according to claim 28, wherein the light gathering means is located between the light emitting means and the fingerprint acquiring means, the ratio of the distance between the light emitting means and the light gathering means and the distance between the light gathering means and the fingerprint acquiring means are n:1, and n is a real number ranging from 1 to 5.

30. The pointing device according to claim 28, wherein the light gathering means is aspherics.

31. A portable terminal device comprising a pointing device described in claim 17 and for simultaneously performing a fingerprint recognition and a pointer control.

32. The portable terminal device according to claim 31, further comprising a display means for displaying previously stored information, wherein the display means displays the whole information or a performing function admitted to the user when a user recognition is performed in the fingerprint recognizing unit, and only displays information and usable functions within a limited range which is previously set when the user recognition is not performed.

33. A pointing method having a fingerprint recognition function, the pointing method of a pointer control device with an image sensor having a smaller size than a predetermined picture image required in a fingerprint recognition, comprising the steps of:
a fingerprint image acquiring step for acquiring at least one or more fingerprint images of M×N pixels depending on a first operating cycle with a predetermined fingerprint acquiring sensor on a finger surface which controls a movable pointer;
a recognition step for determining recognition of a user of the fingerprint image by extracting characteristic points from the acquired fingerprint image depending on a second operating cycle and comparing the extracted characteristic points with those of the previously register fingerprint image;
a fingerprint image extracting step for extracting a fingerprint image of m×n pixels from the acquired fingerprint image depending on a third operating cycle; a movement detecting step for detecting movement information of the respective fingerprint image by calculating displacement data of the respective extracted fingerprint image of M×N pixels; and
an operating step for calculating and outputting a direction and a distance where the pointer is to move with the displacement data.

34. The pointing method according to claim 33, wherein the recognition step comprises: outputting a signal to use the whole information previously set when a user recognition is performed; and outputting a signal to use limited information previously set when a user recognition is not performed.

35. The pointing method according to claim 33, wherein the M and N range from 90 to 400, and the m and the n range from 15 to 80.

36. The pointing method according to claim 33, wherein the third operating cycle is 800˜1200 times/second.

37. The pointing method according to claim 33, wherein the movement detecting step calculating movement distance and direction of characteristic points of the k^{th} fingerprint image from the K−1^{th} fingerprint image to calculate displacement data of each fingerprint image.

38. The pointing method according to claim 33, wherein the image extracting step, the movement detecting step and the operating step is individually performed from the recognition step depending on the third operating cycle.

39. The pointing method according to claim 33, further comprising the steps of: a light emitting step for emitting light with a finger surface which controls the pointer; and a condensing step for condensing a fingerprint image generated by the finger surface with aspherics, wherein the fingerprint acquiring step is to acquire a fingerprint image condensed by the condensing step.

40. The pointing method according to claim 39, wherein the condensing step is to condense the fingerprint image by reducing the size of the fingerprint on the finger surface by 1/n by regulating the aspherisc.

41. The pointing method according to claim 40, wherein the n is a real number ranging from 1 to 5.

42. A pointing device having a fingerprint recognition function, comprising:
at least one or more fingerprint acquiring means for acquiring an image of a finger surface depending on a predetermined cycle or on occasional requirement;
an operating means for calculating displacement data with the acquired fingerprint image to calculate direction and distance where a pointer is to move with the displacement data;
a storing means for mapping a fingerprint image obtained from the fingerprint acquiring means corresponding to the amount of movement in the displacement data received from the operating means; and
a CPU for analyzing and processing data of the operating means and the storing means.

43. The pointing device according to claim 42, wherein the CPU is formed as one package with the operating means and the storing means.

44. The pointing device according to claim 42, wherein the CPU is formed as a structure separate from the operating means and the storing means.

45. The pointing device according to claim 42, further comprising: a light emitting means for emitting light toward the finger surface; and a light gathering means for condensing a fingerprint image reflected from the fingerprint surface, wherein the fingerprint image condensed by the light gathering means is obtained by the fingerprint acquiring means.

46. The pointing device according to claim 45, wherein the light gathering means is located between the light emitting means and the fingerprint acquiring means, the ratio of the distance between the light emitting means and the light gathering means and the distance between the light gathering means and the fingerprint acquiring means are n:1, and n is a real number ranging from 1 to 5.

47. The pointing device according to claim 1, wherein the CPU further comprises a function of processing a fingerprint recognition process in a software way for comparing a fingerprint image stored in the storing means with the fingerprint image received from the fingerprint acquiring means.

48. The pointing device according to claim 42, wherein the storing means periodically stores a fingerprint image depending on a predetermined cycle or stores a fingerprint image only when the storing means receives a request of the CPU.

49. A method for providing service of a portable terminal device having a fingerprint recognition function, the method comprising:
the first step of acquiring a fingerprint image of a user by a pointing device having the fingerprint recognition function, and comprising a previously registered fingerprint image with the acquired fingerprint image to determined recognition of the user; and
the second step of classifying usage rights of a user depending on the determination result in the first step to display a menu corresponding to the usage right.

50. The method according to claim 49, further comprising the third step of enabling a user to use a desired function of the menu displayed in the second step.

51. The method according to claim 50, wherein the second step is to display the whole menu when recognition on the user is performed or to display a specific menu admitted to use when the recognition on the user is not performed.

52. The method according to claim 51, wherein when a user having no recognition intends to use other functions than the menu admitted to use, the message that no use is allowed is displayed and the menu admitted to use is displayed again.

53. The method according to claim 49, wherein the first step is performed as a background process to automatically acquire a fingerprint image while a user performs a navigation with a finger by using the pointing device without performing an additional process to acquire a fingerprint of the user.
